(19) United States
(12) Patent Application Publication
(10) Pub. No.: US 2024/0087418 A1
(43) Pub. Date: Mar. 14, 2024

(54) SPACE-EFFICIENT GUI FOR FEATURE GAME DISPLAY

(71) Applicant: Aristocrat Technologies, Inc., Las Vegas, NV (US)

(72) Inventors: Robert Honeycutt, Henderson, NV (US); Ryan Hawkins, Henderson, NV (US)

(21) Appl. No.: 17/930,610

(22) Filed: Sep. 8, 2022

(51) Int. Cl. G07F 17/32

(52) U.S. Cl. CPC G07F 17/3267; G07F 17/3211; G07F 17/3244

(57) ABSTRACT

Feature game mechanics that allow for special symbols, e.g., cash-on-reel symbols, to potentially award associated awards to a player are provided. Such game mechanics may be triggered when one or more feature game conditions are met. Special symbols that are displayed as part of a game outcome when the feature game is active may have awards associated therewith be added to a player's account but may also be removed from display as part of the game outcome. A new symbol may be selected for each of the removed symbols and displayed in a symbol position in the game outcome display area. This general set of activities may be repeated until there are no special symbols displayed in the symbol positions of the game outcome display area (and the symbol positions of the game outcome display area are otherwise completely filled with symbols).

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

In some games of chance, e.g., slot-type games, there may be certain symbols that, when displayed (or when at least a certain number of them are displayed) as part of a game outcome cause awards specific to each such symbol to be awarded to the player. Such symbols are typically referred to as “cash-on-reel” symbols.

### SUMMARY

As noted above, in some games of chance, some game outcomes may feature one or more symbols of a particular category, e.g., cash-on-reel symbols, that are associated with credit values that may then be awarded to the player. Such symbols, for conciseness, may be referred to as “special” symbols in the discussion below.

In games of chance that feature such special symbols, there may be a feature game that uses the special symbols that is triggerable when one or more feature game conditions are met. For example, one feature game condition that may be met in some games of chance in order to trigger a feature game may be the display of a particular number, e.g., six, of the special symbols as part of a game outcome for the game of chance. In some such implementations, the feature game may be a hold-and-spin game, in which the special symbols are “held” in place and the player is given a limited number of opportunities to engage in further game plays (e.g., reel spins) in which the symbols in symbol positions that do not display a special symbol are randomly re-selected. In such a feature game, each time another special symbol is newly displayed in one of the symbol positions, the number of game plays available to the player in the feature game may be reset or increment by some amount, thereby extending game play. Such a feature game concludes when either the player uses up all of the remaining game plays available in the feature game or when all of the symbol positions in the outcome display area are displaying the special symbol. The feature game then concludes, and the player is awarded an amount equal to the sum of the values associated with the special symbols that are displayed in the game outcome display area.

Such a feature game, however, presents various technical challenges. For example, a typical game of chance, such as a slot game, will afford the player chances to be awarded awards for combinations of symbols that appear as part of a game outcome. In a typical such game of chance, there may be multiple “reels” that each show a plurality of symbols that are randomly selected from a larger set of symbols. Such a game of chance may have multiple “paylines” that include one symbol position from each of the reels; if a certain predefined sequence or combination of symbols appears in the symbol positions along a payline, then the game of chance may award the player with an award associated with that combination or sequence of symbols. However, it is generally the case that the special symbols that may be included in a game outcome are not eligible to be part of a winning pattern along a payline. For example, the winning patterns may be defined so as to not include the special symbols. In such games of chance, each displayed special symbol would thus potentially increase the chance of triggering the feature game (if the number of special symbols displayed as part of a game outcome can potentially trigger the feature game) but, at the same time, decrease the chance of forming a winning pattern along a payline. Moreover, if winning patterns are evaluated at the conclusion of the feature game, there will likely be an even lower chance of obtaining a winning pattern due to the potential for additional special symbols to be obtained during feature game play and held in place in the game outcome display area.

Additionally, such games of chance are limited by the number of symbol positions in the game outcome display area as to the maximum number of special symbols that may be obtained during the feature game. This limits the number of special symbols that may be obtained during feature game play and may thus limit the total amount that the player may win during the feature game. The number of special symbols that may be obtained during feature game play may be increased by expanding the number of symbol positions that are in the game outcome display area, but this may also increase the number of paylines along which a player may obtain winning patterns of symbols, thereby affecting the underlying probabilities of obtaining a winning pattern of symbols along one or more paylines. There is also a practical limit as to how much such a game outcome display area may be expanded, e.g., there may only be a certain number of additional symbol positions that may be able to be fit within a given game outcome display area (assuming that the symbol positions are each of a predefined shape and size)

The present inventors conceived of a game mechanic that allows a player to obtain awards associated with special symbols a) without potentially blocking the formation of winning patterns along paylines and b) while allowing the player to potentially earn a number of awards associated with special symbols that exceeds the number of symbol positions in the outcome display area. This allows for a more compact display of the game elements in a game display graphical user interface.

In such a game mechanic, when the feature game is triggered, the game of chance may cause any award or awards that are associated with any special symbols that are displayed in a symbol position as part of the game outcome to be awarded to the player. The special symbols may then be caused to be removed from the game outcome display area. A new symbol may then be selected and displayed in the game outcome display area for each such removed symbol. This process may repeat until there are no further special symbols displayed in the game outcome display area. It will be readily apparent that a player may, if the right sequence of symbols is selected in some implementations, potentially obtain awards associated with a number of special symbols that is higher than the total number of symbol positions that is displayed in the game outcome display area. Moreover, once there are no more special symbols displayed in the game outcome display area at the conclusion of the feature game, there is no possibility that a special symbol displayed in the game outcome display area will potentially block display of a winning pattern of symbols in the game outcome display area. This allows the game outcome display area to be maintained at a particular size while allowing a feature game to be presented that allows for a number of potential awards to be made that exceeds the number of symbol positions in the game outcome display area and providing a number of paylines for winning patterns that is commensurate with that particular size.

In some implementations, a system may be provided that includes one or more displays, one or more processors, and one or more memory devices. The one or more memory devices may store computer-executable instructions which, when executed by the one or more processors, cause the one or more processors to present a game of chance featuring a game outcome display area, the game outcome display area including a plurality of strips of symbol positions, each strip of symbol positions associated with a corresponding set of symbols and determine a game outcome for the game of chance responsive to receipt of an input signal indicating a play of the game of chance by: a) causing, for each symbol position in each strip of symbol positions, a symbol from the corresponding set of symbols associated with that strip of symbol positions to be selected and displayed as a displayed symbol in that symbol position, b) determining whether one or more feature game conditions have been met, c) causing, responsive to determining that the one or more feature game conditions have been met, each displayed symbol that is of the first category of symbol to be removed from the game outcome display area and thereby become a removed symbol, d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed, e) repeating (c) and (d) until none of the symbols displayed concurrently in the symbol positions of the strips of symbol positions are of the first category of symbol, f) causing, responsive to determining that the one or more feature game conditions have been met and for each displayed symbol of the first category of symbol that is displayed as part of the game outcome, a corresponding feature game award to be added to a credit balance associated with the game of chance, g) determining whether the symbols displayed in the game outcome display area form one or more winning patterns, and h) causing, for each winning pattern that is determined to be formed by the symbols displayed in the game outcome display area, a corresponding winning pattern award to be added to the credit balance.

In some implementations, the symbol positions in each strip of symbol positions may lie along a corresponding path, the symbols in each set of symbols may be in a predefined order, and the one or more memory devices may further store additional computer-executable instructions which, when executed by the one or more processors, cause the one or more processors to: cause the symbols that are selected and displayed in the symbol positions of each strip of symbol positions to be displayed in the strip of symbol positions, and select and display the symbols from each set of symbols in the same order that those symbols are in within that set of symbols.

In some further such implementations, the one or more memory devices may further store additional computer-executable instructions which, when executed by the one or more processors, cause the one or more processors to cause each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

In some implementations, the first category of symbols may include two or more cash-on-reel symbols that are each associated with a different award amount.

In some implementations, the one or more feature game conditions may be met when at least a predetermined number of symbols of the first category of symbols are concurrently displayed in the game outcome display area as part of the game outcome.

In some implementations, the one or more memory devices may further store additional computer-executable instructions which, when executed by the one or more processors, cause the one or more processors to at least perform (g) and (h) after none of the symbols displayed concurrently in the symbol positions of the strips of symbol positions are of the first category of symbol.

In some implementations, the one or more memory devices may further store additional computer-executable instructions which, when executed by the one or more processors, cause the one or more processors to also perform (g) and (h) at least once in between (a) and (g).

In some implementations, a method may be provided that includes presenting a game of chance featuring a game outcome display area, the game outcome display area including a plurality of strips of symbol positions and each strip of symbol positions associated with a corresponding set of symbols and determining a game outcome for the game of chance responsive to receipt of an input signal indicating a play of the game of chance by: a) causing, for each symbol position in each strip of symbol positions, a symbol from the corresponding set of symbols associated with that strip of symbol positions to be selected and displayed as a displayed symbol in that symbol position, b) determining whether one or more feature game conditions have been met, c) causing, responsive to determining that the one or more feature game conditions have been met, each displayed symbol that is of the first category of symbol to be removed from the game outcome display area and thereby become a removed symbol, d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed, e) repeating (c) and (d) until none of the symbols displayed concurrently in the symbol positions of the strips of symbol positions are of the first category of symbol, f) causing, responsive to determining that the one or more feature game conditions have been met and for each displayed symbol of the first category of symbol that is displayed as part of the game outcome, a corresponding feature game award to be added to a credit balance associated with the game of chance, g) determining whether the symbols displayed in the game outcome display area form one or more winning patterns, and h) causing, for each winning pattern that is determined to be formed by the symbols displayed in the game outcome display area, a corresponding winning pattern award to be added to the credit balance.

In some such implementations, the symbol positions in each strip of symbol positions may lie along a corresponding path, the symbols in each set of symbols may be in a predefined order, and the method may further comprise: causing the symbols that are selected and displayed in the symbol positions of each strip of symbol positions to be displayed in the strip of symbol positions, and selecting and displaying the symbols from each set of symbols in the same order that those symbols are in within that set of symbols.

In some such implementations, the method may further include causing each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

In some implementations, the first category of symbols may include two or more cash-on-reel symbols that are each associated with a different award amount.

In some implementations, the one or more feature game conditions may be met when at least a predetermined number of symbols of the first category of symbols are concurrently displayed in the game outcome display area as part of the game outcome.

In some implementations, the method may further include at least performing (g) and (h) after none of the symbols displayed concurrently in the symbol positions of the strips of symbol positions are of the first category of symbol.

In some such implementations, the method may further include performing (g) and (h) at least once in between (a) and (g).

In some implementations, one or more non-transitory, computer-readable media may be provided which store computer-executable instructions which, when executed by one or more processors, cause the one or more processors to: cause a game of chance to be presented on one or more displays of a gaming machine and featuring a game outcome display area, the game outcome display area including a plurality of strips of symbol positions, each strip of symbol positions associated with a corresponding set of symbols and determine a game outcome for the game of chance responsive to receipt of an input signal indicating a play of the game of chance by: a) causing, for each symbol position in each strip of symbol positions, a symbol from the corresponding set of symbols associated with that strip of symbol positions to be selected and displayed as a displayed symbol in that symbol position, b) determining whether one or more feature game conditions have been met, c) causing, responsive to determining that the one or more feature game conditions have been met, each displayed symbol that is of the first category of symbol to be removed from the game outcome display area and thereby become a removed symbol, d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed, e) repeating (c) and (d) until none of the symbols displayed concurrently in the symbol positions of the strips of symbol positions are of the first category of symbol, f) causing, responsive to determining that the one or more feature game conditions have been met and for each displayed symbol of the first category of symbol that is displayed as part of the game outcome, a corresponding feature game award to be added to a credit balance associated with the game of chance, g) determining whether the symbols displayed in the game outcome display area form one or more winning patterns, and h) causing, for each winning pattern that is determined to be formed by the symbols displayed in the game outcome display area, a corresponding winning pattern award to be added to the credit balance.

In some such implementations, the symbol positions in each strip of symbol positions may lie along a corresponding path, the symbols in each set of symbols may be in a predefined order, and the one or more non-transitory, computer-readable media may further store computer-executable instructions which, when executed by the one or more processors, cause the one or more processors to: cause the symbols that are selected and displayed in the symbol positions of each strip of symbol positions to be displayed in the strip of symbol positions, and select and display the symbols from each set of symbols in the same order that those symbols are in within that set of symbols.

In some such implementations, the one or more non-transitory, computer-readable media may further store additional computer-executable instructions which, when executed by the one or more processors, cause the one or more processors to cause each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

In some implementations, the first category of symbols may include two or more cash-on-reel symbols that are each associated with a different award amount.

In some implementations, the one or more feature game conditions may be met when at least a predetermined number of symbols of the first category of symbols are concurrently displayed in the game outcome display area as part of the game outcome.

In some implementations, the one or more non-transitory, computer-readable media may further store additional computer-executable instructions which, when executed by the one or more processors, cause the one or more processors to at least perform (g) and (h) after none of the symbols displayed concurrently in the symbol positions of the strips of symbol positions are of the first category of symbol.

In some implementations, the one or more non-transitory, computer-readable media may further store additional computer-executable instructions which, when executed by the one or more processors, cause the one or more processors to also perform (g) and (h) at least once in between (a) and (g).

### BRIEF DESCRIPTION OF THE DRAWINGS

FIG. 1 is an exemplary diagram showing several EGMs networked with various gaming-related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4 through 11 depict different states in a game of chance.

FIGS. 12 through 19 depict different states of a GUI that may be used to present a game of chance as shown in FIGS. 4 through 11.

FIG. 20 depicts a flow chart of a mechanism for offering a feature game that facilitates a more compact display of a game of chance.

The Figures are provided for the purpose of providing examples and clarity regarding various aspects of this disclosure and are not intended to be limiting.

### DETAILED DESCRIPTION

As discussed above, this disclosure is directed at games of chance that feature a feature game mechanic that allows for providing an expanded opportunity for potential feature game winnings without a requisite expansion of the game outcome display area. Moreover, games of chance including such a feature game mechanic may provide the feature game without potentially limiting the achievement of winning patterns along paylines, as may typically be the case when feature games that utilize special symbols such as those discussed above are triggered.

The following discussion provides overall context for gaming machines that may be used to implement a feature game mechanic such as is described above and later herein. Following this overview, a more focused discussion of the feature game mechanic concepts discussed above is provided.

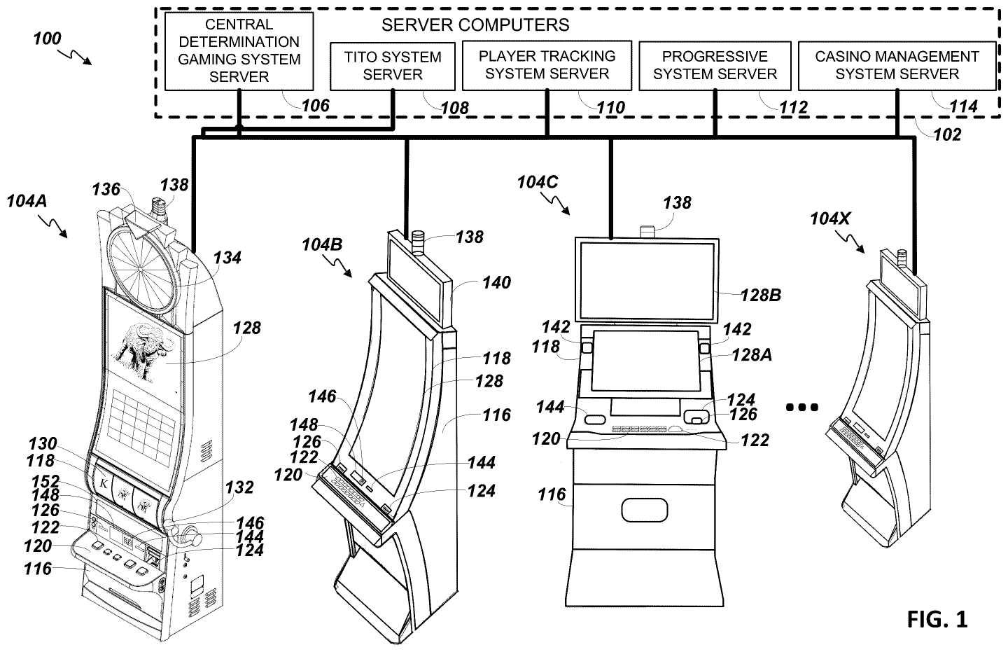

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Reim XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

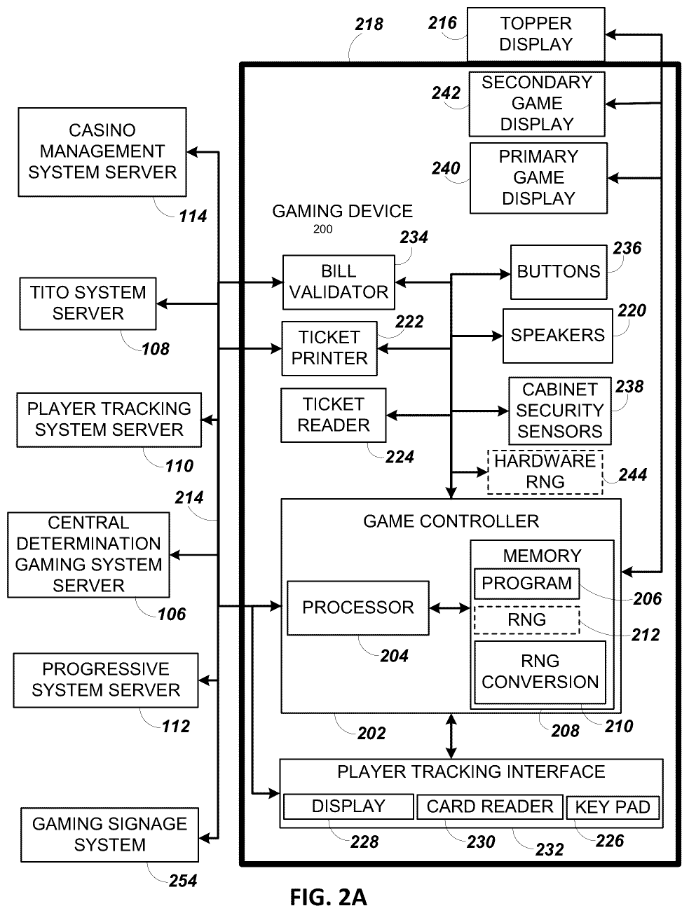

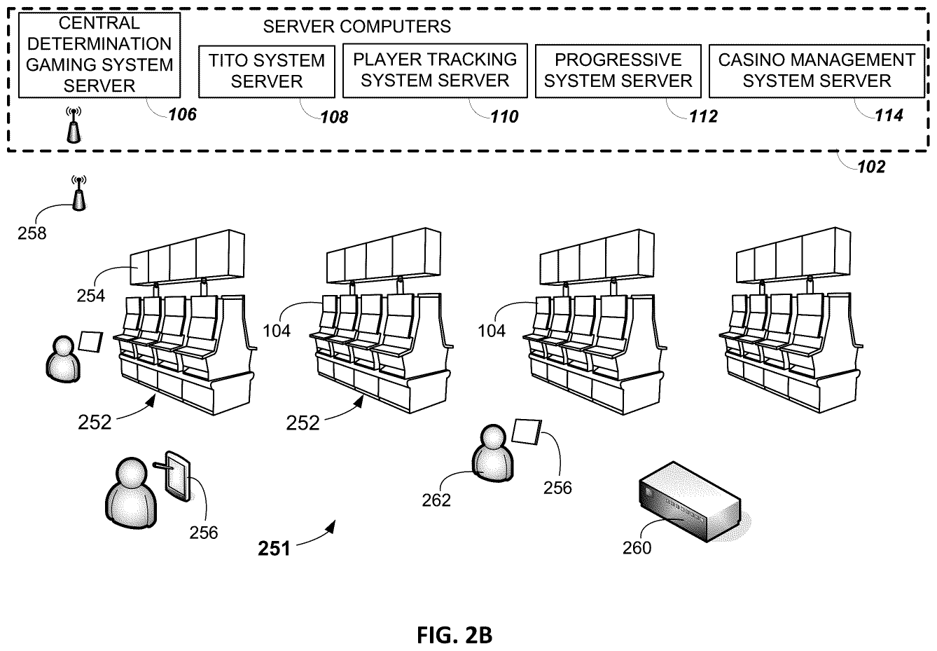

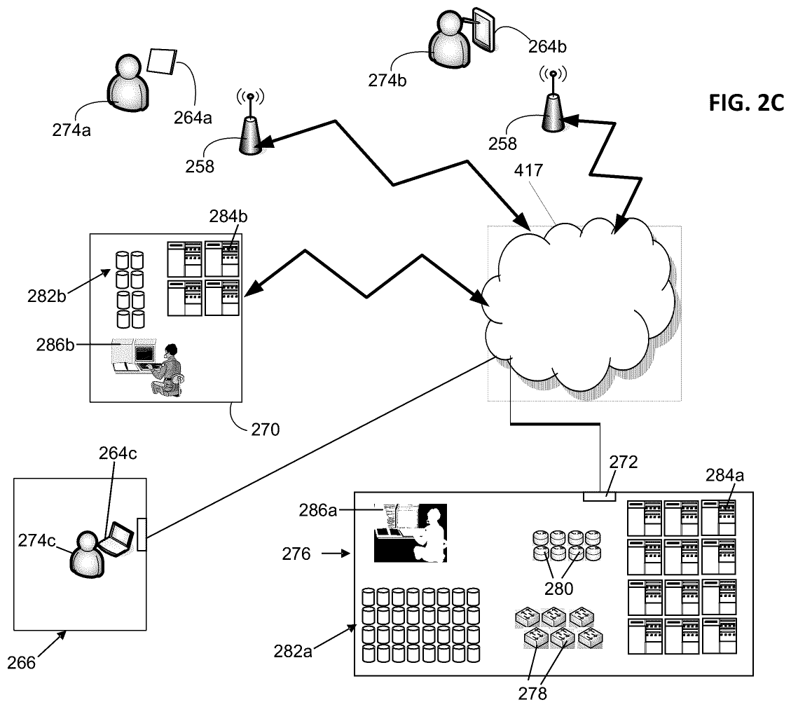

Many or all the above described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2 also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 may, for example, be a remote gaming server (RGS) or similar system in some implementations. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 570a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

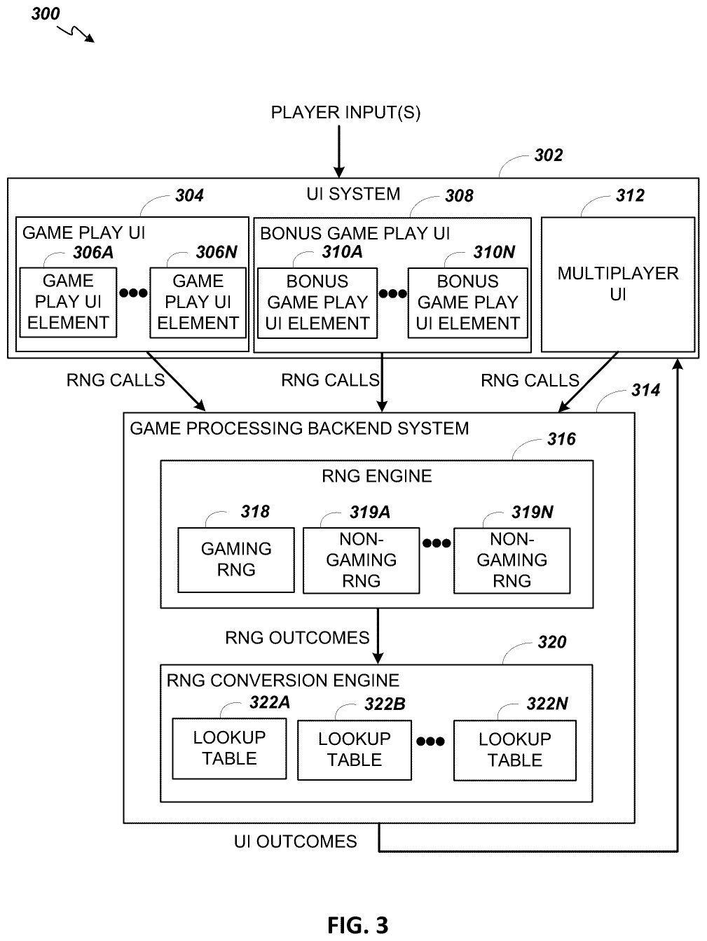

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

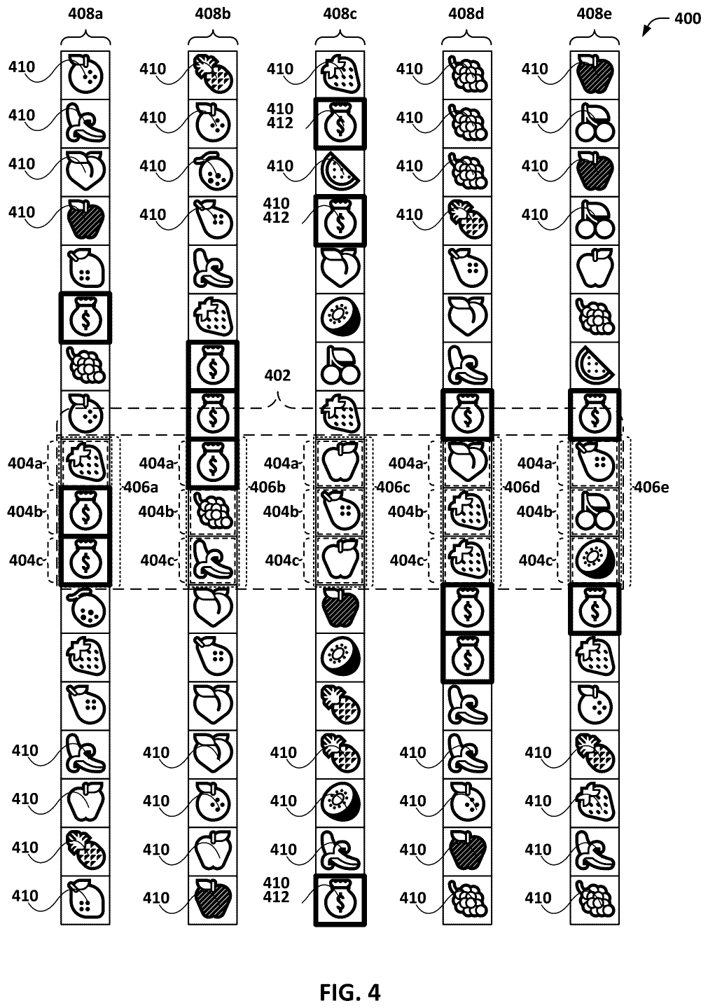

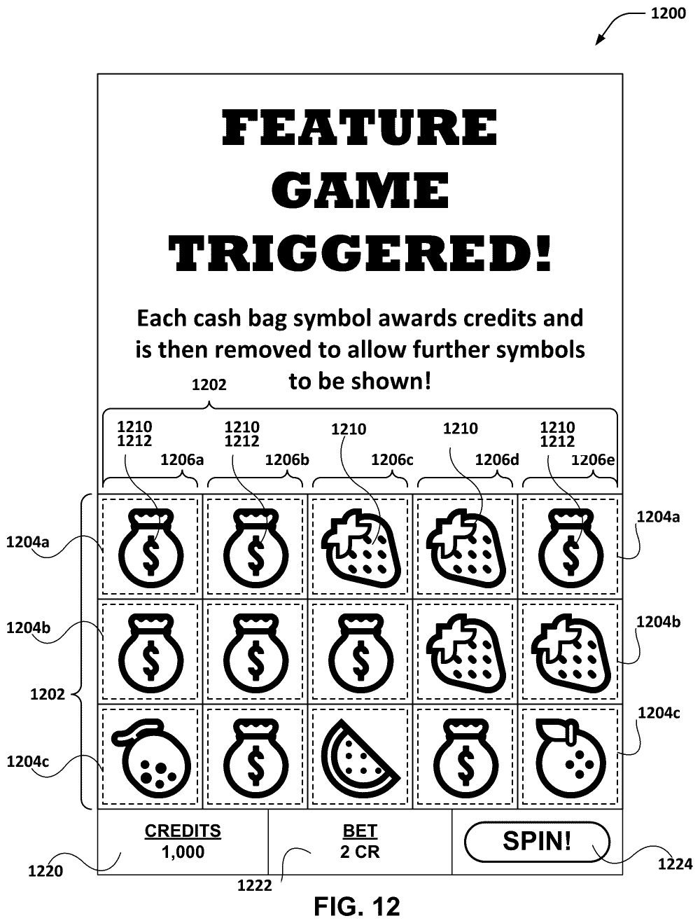

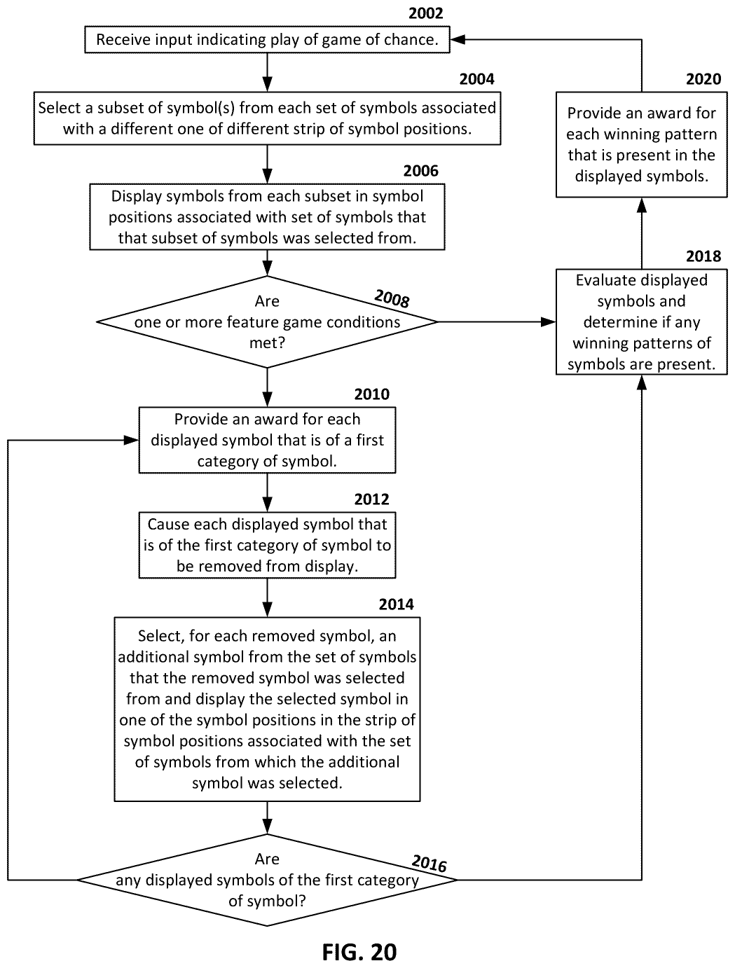

While the above-discussed Figures and discussion have focused on general aspects of gaming machines and systems that may be used to provide games of chance, the following discussion regarding FIGS. 4 through 11, FIGS. 12 through 19, and FIG. 20 turns the focus to the conceived feature game mechanic that allows for a more compact game GUI, e.g., a game GUI that may be more suitable to displays with limited screen real estate, such as smartphone displays. FIGS. 4 through 11 depict various states of play of a game of chance having a feature game mechanic such as that discussed above. FIGS. 12 through 19 depict a portion of the game play of FIGS. 4 through 11 but in the context of a game presentation GUI. FIG. 20 depicts a flow chart of a technique of providing the feature game mechanics discussed herein.

As can be seen in FIG. 4, a game of chance 400 may have a game outcome display area 402 that includes a plurality of strips 406 of symbol positions 404. In this example, the game outcome display area 402 includes five strips 406a-e, each of which includes three symbol positions 404a-c. It will be understood, however, that the game outcome display area may include different numbers of strips 406 and/or different numbers of symbol positions 404 in each strip 406. Moreover, while the strips 406 in the example of FIG. 4 each include the same number of symbol positions 404, other implementations of such a game of chance may feature one or more strips 406 of symbol positions 404 that have more or fewer symbol positions 404 than one or more other strips of symbol positions 404. For example, in some implementations, a game of chance may have five strips 406 arranged so as to be parallel to each other, as in FIG. 4, but with the interior three strips 406 having five symbol positions 404 each and the outer two strips 406 having three symbol positions 404. It will also be appreciated that while the strips 406 of symbol positions 404 are shown with the symbol positions 404 thereof arranged so as to lie along vertical axes, other implementations may feature strips 406 in which the symbol positions are arranged along non-vertical axes, e.g., along horizontal axes.

Each strip 406 may be associated with a corresponding set 408 of symbols 410 from which symbols 410 may be selected for display in the symbol positions 404 of that strip 406. Each set 408 of symbols 410 may, for example, be, in effect, a virtual reel strip in a slot game and the symbols 410 within each set 408 may be arranged in a particular order and treated as a continuous list, e.g., such that when one iterates through the set 408 and reaches the end of the set 408, the next symbol 410 that is selected will be the first symbol 410 in the set 408.

The sets 408 of symbols 410 in FIG. 4 are each identical in size, featuring 18 symbols 410 each, with all symbols 410 being static in nature (i.e., none of the symbols 410 will be other than the symbol 410 shown). However, other implementations may utilize sets 408 of symbols 410 in which one or more symbols 410 may be dynamic, e.g., replaced, when selected for display, with one or more other symbols 410 that are to be displayed. Moreover, other implementations may have sets 408 of symbols 410 that are much larger in size, e.g., including dozens or hundreds of instances of symbols 410. It will also be understood that while the sets 408 of symbols 410 of FIG. 4 are shown as all being the same size as each other, at least some such sets 408 of symbols 410 may, in some implementations, have different numbers of symbols 410 in them.

The symbols 410 in at least one set 408 of symbols 410 may include one or more symbols 410 that are of a first category of symbols, e.g., cash-on-reel symbols or other symbols that may operate like the “special” symbols discussed earlier herein. In some implementations, only one set 408 of symbols 410 may include symbols 410 that are of the first category of symbols, while in other implementations, two or more, or even all, of the sets 408 of symbols 410 may each include one or more symbols 410 of the first category of symbols. In the sets 408 of symbols 410, the symbols 410 that are of the first category of symbols are indicated by “money bag” images, although it will be recognized that there may be multiple different types of symbols 410 that are in the first category of symbols, as opposed to just the single type of symbol shown in FIG. 4. The symbols 410 that are of the first category of symbols in FIG. 4 are indicated by the square that contains them being shown as having a heavy-weight black line boundary and by, in some cases, callout 412. The other symbols 410 may be viewed as being of a second category of symbols 410 in which the symbols 410 in the second category of symbols are those symbols 410 that are not in the first category of symbols 410.

Whenever a play of the game of chance 400 is initiated, symbols may be selected from each set 408 of symbols 410, e.g., randomly (or via a weighted random selection), and then displayed in the symbol positions 404 in the strip 406 of symbol positions 404 that is associated with that set 408 of symbols 410. For example, in some implementations, the symbols 410 that are in each set 408 of symbols 410 may be set in a specified order, e.g., similar to how symbols are arranged on a reel strip on a physical slot machine reel, and a random selection of X sequentially adjacent symbols 410 in the set 408 of symbols 410 may be made, where X is the number of symbol positions 404 that are in the strip 406 of symbol positions 404 associated with that set 408 of symbols 410. The selected symbols 410 may then be displayed in the strip 406 of symbol positions 404 such that they appear in the same order or sequence that those symbols 410 are in in the set 408 of symbols 410 from which they were selected. In FIG. 4 and the following Figures, each set 408 of symbols 410 is shown as a representative “strip” of symbols that is positioned such that three of the symbols 410 on each such “strip” are positioned within three symbol positions 404 of each strip 406 of symbol positions 404, with the rest of the strip of symbols 410 sticking out of either end of the game outcome display area. This is, of course, a figurative representation, as the symbols 410 in each set would generally be represented as references in a data table to graphical resources representing associated symbol images or animations instead of a single large image of multiple symbols 410 that has a portion thereof displayed within the strip 406 of symbol positions 404.

In other implementations, symbols 410 may be selected from each set 408 of symbols 410 and displayed in the symbol positions 404 entirely randomly, e.g., without regard for any order the symbols 410 may be in within each set 408 of symbols 410. However, implementations in which the symbols 410 are selected from each set 408 of symbols 410 such that the selected symbols 410 are presented in the same order they are in within the set 408 of symbols may provide a more satisfying game play experience, as players may begin to recognize when particular patterns of symbols 410 displayed in a strip 406 of symbol positions 404 may lead to a particular outcome.

Once a game outcome has been determined responsive to a play of the game of chance 400, a determination may be made as to whether or not to activate a feature game associated with the game of chance 400. Such a determination may also be made, in some cases, prior to when the game outcome is determined. Activation of the feature game may be triggered by the satisfaction of one or more feature game conditions. Such conditions may, in some instances, be satisfied when the game outcome includes at least a specified number of symbols 410 that are of the first type of category (or of some other category) being displayed as part of the game outcome. For example, if a game outcome is obtained that includes at least a display of six symbols 410 that are of the first category of symbol 410, this may, in some cases, be sufficient to cause the feature game to be activated. In some implementations, there may be alternative or additional such feature game conditions that may alternatively or additionally trigger the feature game. For example, if a particular symbol 410 (which may or may not be of the first category of symbols 410) is depicted in one of the symbol positions 404, either in the current play of the game of chance or, in some cases, a past play of the game of chance, then this may serve to satisfy the one or more feature game conditions. Other conditions that may satisfy the feature game conditions may include, for example, a player achieving a particular credit balance in the game of chance, a player winning a certain total amount while playing the game of chance, a player engaging in a predetermined number of plays of the game of chance, a player obtaining a particular pattern of symbols 410 in a game outcome (a particular pattern of symbols 410 of the first category of symbols or, alternatively or additionally, a particular pattern of any symbol 410, regardless of whether or not the symbols 410 are of the first category of symbol 410, or a player obtaining at least one symbol 410 of the first category of symbol 410 in at least a predetermined number of strips of symbol positions).

In this particular example, the feature game conditions may be met when a game outcome displays six or more symbols 410 that are of the first category of symbol. In the game outcome shown in FIG. 4, there are only three symbols 410 (two in symbol positions 404b and 404c of the first strip 406a of symbol positions 404 and one in symbol position 404a of the second strip 406b of symbol position 404) of the first category of symbols shown. Accordingly, the feature game is not triggered in response to the displayed game outcome. In some implementations, the symbols 410 of the first category of symbols 410 that are shown as part of the game outcome may, when the feature game is not triggered, simply be inactive symbols having no special effect. In other implementations, the symbols 410 of the first category of symbols that are shown as part of a game outcome under such conditions may have awards associated therewith be awarded to the player. In yet other or additional such implementations, such symbols 410 may be treated as “wild” symbols that may be used in place of any other symbol 410 in determining whether a winning pattern is displayed.

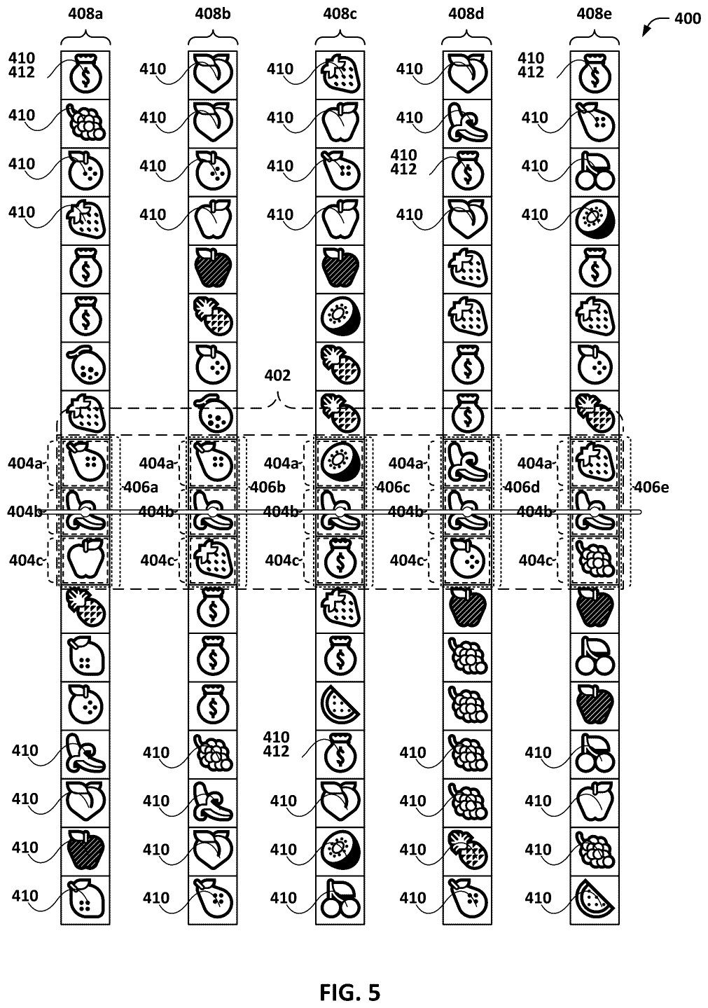

In FIG. 5, a further play of the game of chance has occurred and newly selected symbols 410 are displayed in the symbol positions 404. The sets 408 of symbols 410 are the same as in FIG. 4, but the sets 408 of symbols 410 have been shifted such that a different sub-sets of three symbols 410 from each set 408 of symbols 410 is shown in each strip 406 of symbol positions 404. Leading or trailing portions of each ordered set 408 of symbols 410 may have been trimmed off and moved to the other end of each ordered set 408 such that sets 408 of symbols 410 are generally all in the same relative positions. This is purely for avoiding clutter and remaining within the boundaries of the page, however.

In the game outcome of FIG. 5, there is only one symbol 410 that is of the first category of symbol. The feature game is thus not triggered. However, the game outcome does include a winning symbol 410 pattern in the form of five banana symbols 410 in symbol positions 404b along a payline. The winning symbol pattern may result in a winning symbol pattern payout, e.g., of an award associated with that particular winning pattern of symbols.

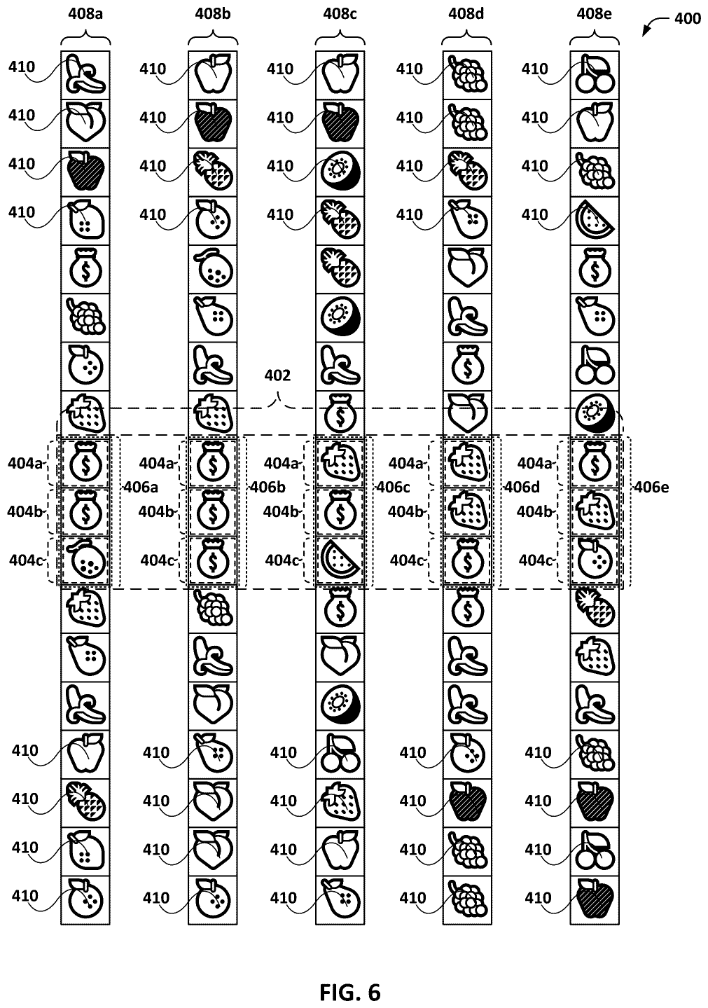

FIG. 6 depicts a further game outcome for the game of chance of FIG. 4. In the game outcome of FIG. 6, there are eight symbols 410 of the first category of symbol 410. This is sufficient to trigger the feature game.

In the feature game, the symbols 410 of the first category of symbols that are displayed in the game outcome display area are identified and removed from display. An award associated with each such symbol 410 of the first category of symbol 410 that is displayed and then removed may be awarded to the player playing the game of chance, e.g., each such symbol 410 may feature an award amount, e.g., a credit amount, that is to be awarded to the player on display of the associated symbol 410 that is of the first category of symbol 410 during the feature game.

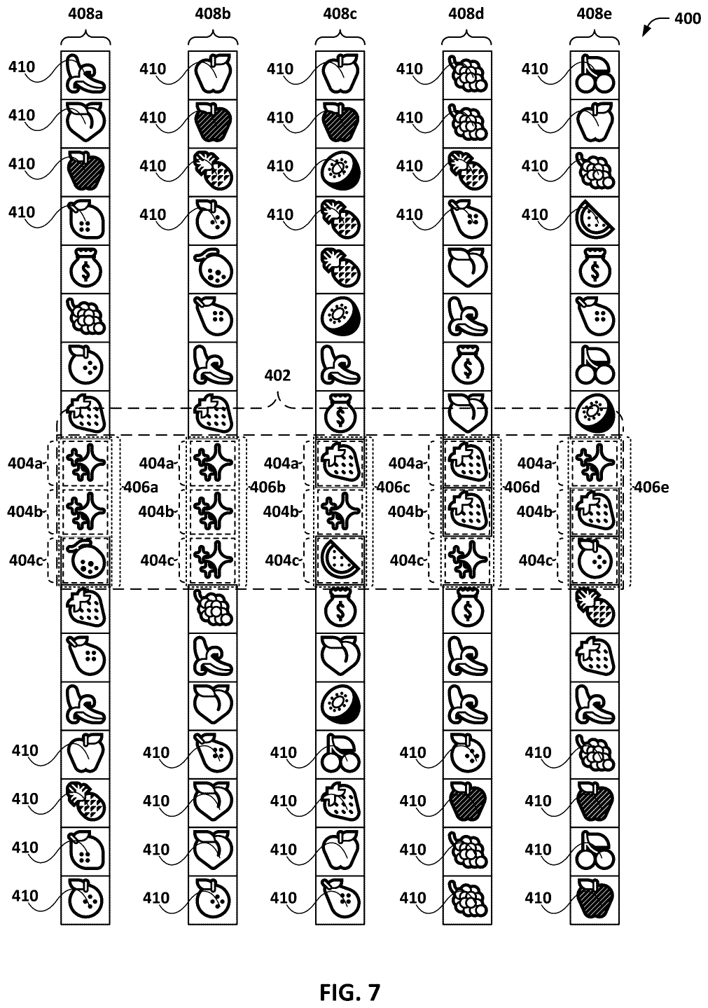

FIG. 7 depicts the game outcome display area 402 of FIG. 6 as the symbols 410 of the first category of symbols are caused to be removed. In this example, a sparkling star animation is played in place of each such symbol 410 of the first category of symbols that is being removed, but other animations may be used to similar effect.

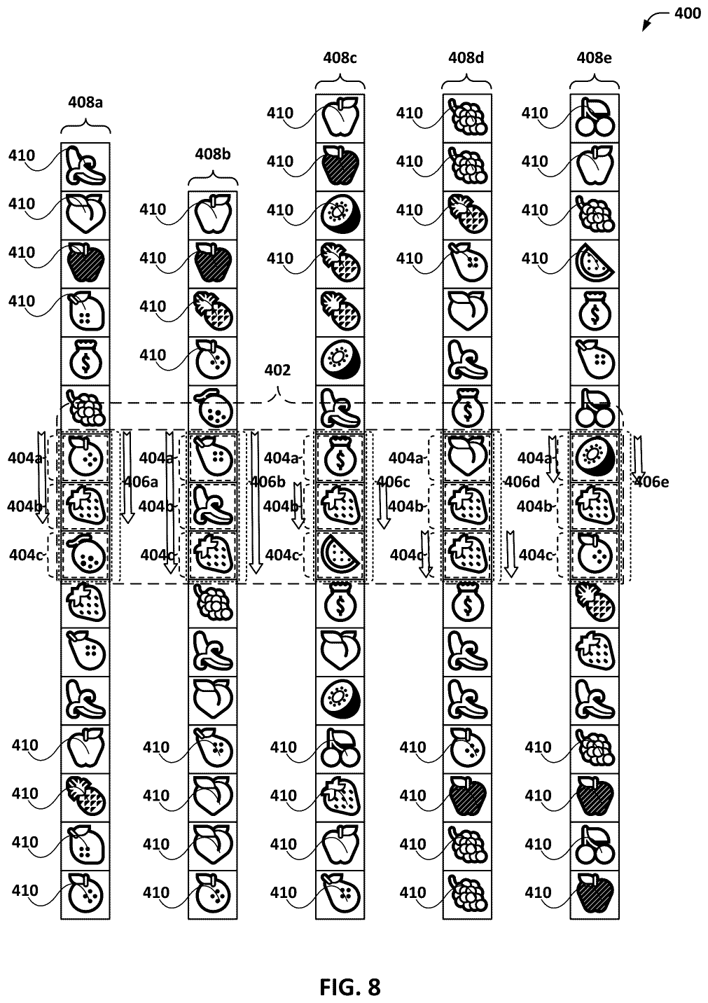

FIG. 8 depicts the game outcome of FIG. 6 after the symbols 410 of the first category of symbols that were initially visible in the game outcome display area 402 have been removed and after additional symbols 410 selected from the sets 408 of symbols 410 have been caused to be displayed in symbol positions 404 of the strips 406 of symbol positions 404 from which the symbols 410 of the first category of symbols 410 have been removed. In some implementations, as shown in FIG. 8, a symbol or symbols 410 that are sequentially adjacent to each removed symbol 410 (either within the game outcome display area or in the set 408 of symbols associated with the strip 406 of symbol positions 404 from which the removed symbol 410 was removed) may be caused to move towards the symbol position 404 from which the removed symbol 410 was removed. In examples in which the symbols 410 in each set 408 of symbols 410 are animated so as to traverse through the symbol positions 404 of the associated strip 406 of symbol positions 404 prior to selection, thereby approximating the look and feel of symbols on a reel spinning past the symbol positions 404 in a traditional slot game, the movement of symbols 410 after the removal of any symbol 410 of the first category of symbol 410 may be caused to be in the same direction as the earlier movement of symbols during the initial display of symbols 410 in the game outcome. In games of chance in which there are vertically oriented strips 406 of symbols 410, it may be common to make it appear that the symbols 410 initially selected for display in the symbol positions 404 as part of a game outcome scroll vertically downward through each strip 406 of symbol positions 404 before slowing and stopping with a particular subset of the symbols 410 in the set 408 of symbols 410 being displayed in the symbol positions 404 of the strip 406 of symbol positions 404. In such implementations, when a symbol or symbols 410 of the first category of symbol 410 is or are removed, the symbols that are “above” that removed symbol 410 or the removed symbols 410 in the set 408 of symbols 410 may be caused to move vertically downward such that the order of the symbols 410 that are displayed in the symbol positions 404 of the associated strip 406 of symbol positions 404 reflects the order of those symbols 410, with the symbols 410 of the first category of symbols 410 omitted, in the associated set 408 of symbols 410. Thus, when a symbol 410 of the first category of symbol 410 is removed, the symbols 410 “above” that removed symbol may appear to cascade or fall into the symbol position 404 formerly occupied by the removed symbol 410. The arrows shown bracketing each strip 406 of symbol positions 404 in FIG. 8 indicate how the symbols 410 that are now shown in the symbol positions 404 from which removed symbols 410 were removed moved in order to fill those vacated symbol positions 404.

Put another way, such an animation may cause an additional symbol to move into an end-most symbol position of the symbol positions of the strip of symbol positions in which that additional symbol is to be displayed. In such an animation, each displayed symbol, if any, in a symbol position between that end-most symbol position and the symbol position of the removed symbol that the additional symbol was selected responsive to moves along a path along which the symbol positions of that strip are arranged and away from the end-most symbol position.

As can be seen in FIG. 8, one of the newly selected and displayed symbols 410 in the middle strip 406c of symbol positions 404 is yet another symbol 410 of the first category of symbol 410. As with the symbols 410 of the first category that were initially displayed in the game outcome in which the feature game was triggered, the symbol 410 of the first category of symbol 410 in the symbol position 404a of the strip 406c of symbol positions 404 may be removed and an award associated therewith provided to the player.

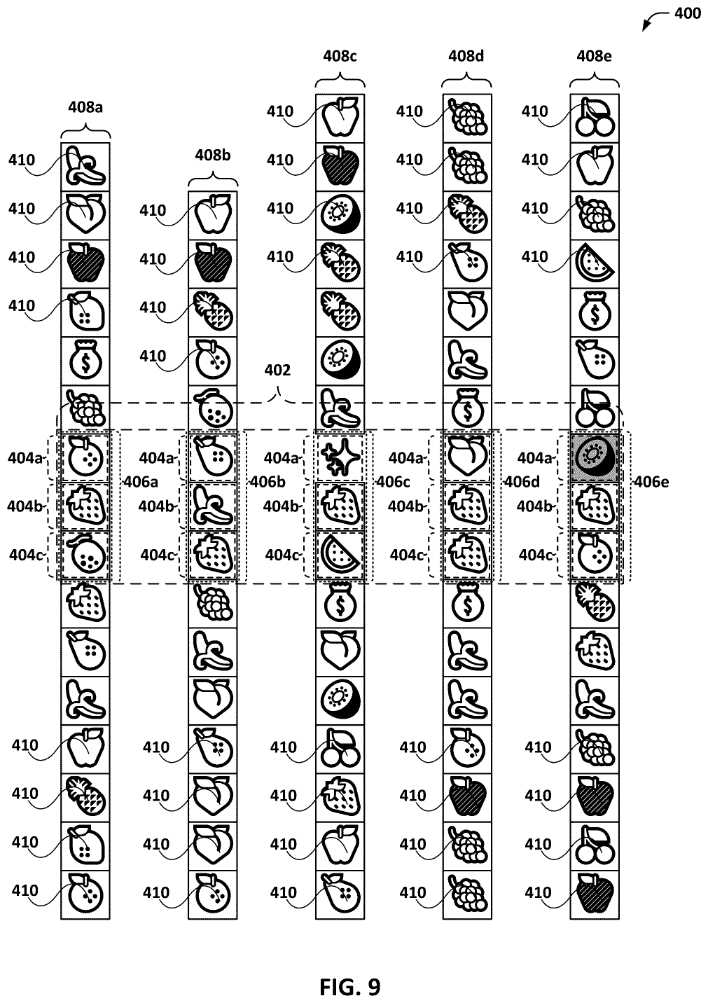

FIG. 9 depicts the game outcome display area 402 of FIG. 8 as the symbol 410 of the first category of symbols in the symbol position 404a of the strip 406c of symbol positions 404 is caused to be removed. In this example, as with the earlier example, a sparkling star animation is played in place of the symbol 410 of the first category of symbols that is being removed, but other animations may be used to similar effect.

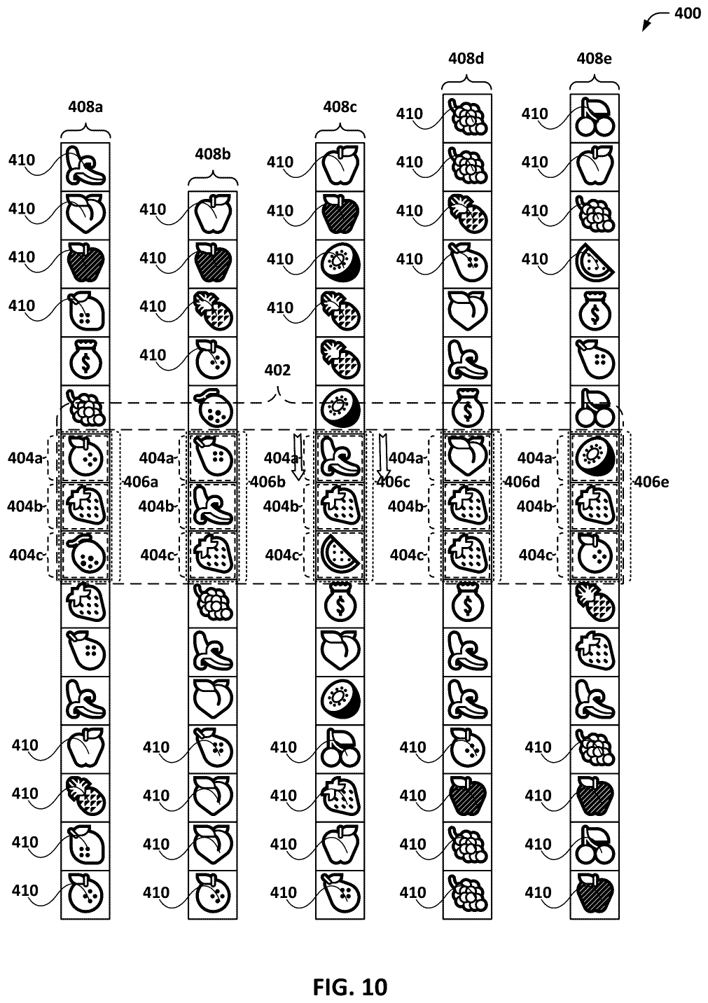

FIG. 10 depicts the game outcome display area 402 after the removed symbol 410 of the first category of symbols 410 has been removed and a further symbol 410 selected from the set 408 of symbols 410 associated with the strip 406 of symbol positions 404 from which the removed symbol 410 was removed has been displayed. The arrows shown bracketing the strip 406c of symbol positions 404 in FIG. 10 indicate how the symbol 410 that is now shown in the symbol position 404a of the strip 406c of symbol positions 404 moved in order to fill the symbol positions 404a of the strip 406c of symbol positions 404.

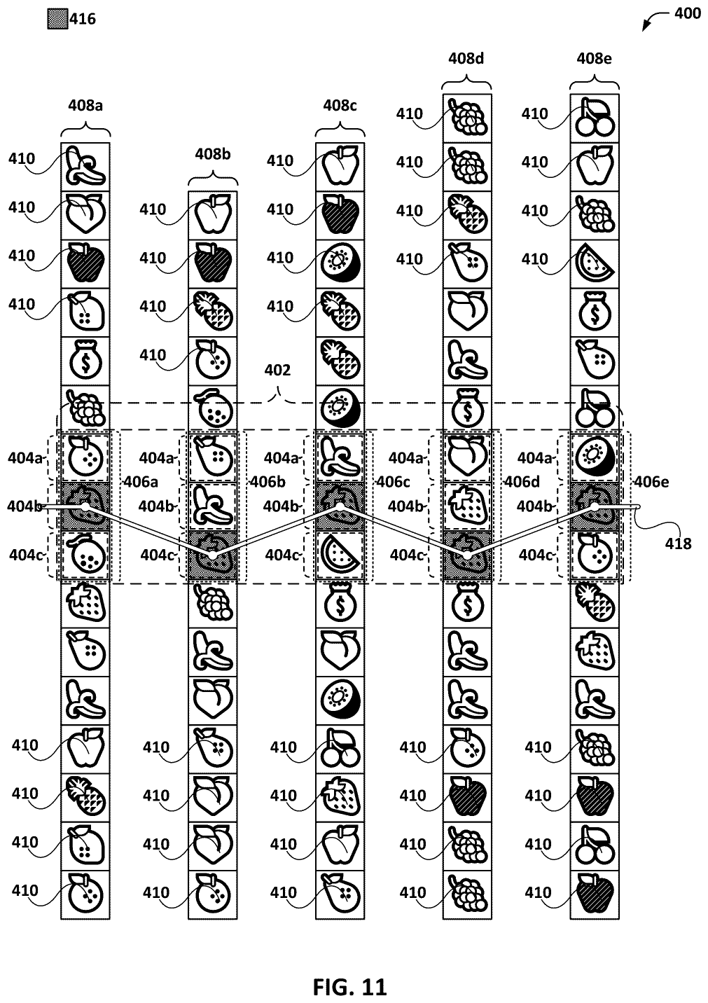

As there are no more symbols 410 of the first category of symbols 410 that are shown in the game outcome display area 402 in FIG. 10, there are no further symbols of the first category to remove and a determination may be made that the feature game is complete. At the conclusion of the feature game, the symbols 410 that are shown in the game outcome display area 402 may be evaluated to determine if there are any winning patterns of symbols 410. For example, as shown in FIG. 11, the symbols 410 that are displayed in the game outcome display area 402 form a winning pattern 416 of five strawberries along a zig-zag payline 418. It will be noted that this winning pattern 416 did not exist in the game outcome display area at the start of the feature game and that it only resulted due to the removal of the symbols 410 that were of the first category of symbols 410 during the feature game.

It will be appreciated that in some implementations, an evaluation of the symbols shown in the game outcome display area 402 for winning patterns 416 along paylines 418 maybe made during the feature game as well as after the feature game concludes. For example, each time that a symbol or symbols 410 of the first category of symbols 410 is removed and replacement symbols 410 are caused to be displayed in the game outcome display area 402 during the feature game, there may be a re-evaluation of the displayed symbols 410 to see if any winning patterns 416 are reflected in the symbols 410 that are displayed in the game outcome display area 402. In such implementations, players may win awards associated with winning patterns multiple times during a feature game.

As noted earlier, FIGS. 12 through 19 depict an example GUI that may be used to provide a game of chance similar to that discussed above. In particular, the various game states reflected in FIGS. 12 through 19 correspond to the same game outcomes shown in FIGS. 6 through 11.

For example, FIG. 12 depicts a GUI for a game of chance 1200 that is similar to the game of chance 400 of FIG. 4 in which a game outcome display area 1202 is shown that has five strips 1206a-e of symbol positions 1204 that each have three symbol positions 1204a-c. The GUI also includes a credit balance indicator 1220, a bet level indicator 1222, and a play button 1224. The credit balance indicator 1220 may be used to display the total number of credits that are available to the player and may be debited for each play of the game based on the bet level indicated by the bet level indicator and incremented by amounts won by the player during play of the game (or when the player adds additional credits to the credit balance via, for example, purchasing credits). The bet level indicator 1222 may indicate an amount of credits from the credit balance that may be wagered each time a play of the game of chance 1200 is initiated. Finally, the play button 1224 may be selected by a player to provide an input to the game of chance that causes a play of the game of chance to occur.

Each time a play of the game of chance 1200 is initiated, symbols 1210 may be selected from sets of symbols, e.g., similar to the sets 408 of symbols 410, and then displayed in the symbol positions 1204 of each strip 1206 of symbol positions 1204. The

As can be seen in FIG. 12, the game outcome that is depicted is the same game outcome shown in FIG. 6. There are eight symbols 1210 that are of the first category of symbols, e.g., symbols 1212 (only some are called out). The symbols 1212 are money-bag symbols in this example. As in the game of chance 400, the feature game in the game of chance 1200 may be triggered when six or more symbols 1210 (1212) of the first category of symbols 1210 are displayed as part of a game outcome displayed in the game outcome display area 1202. Since there are eight symbols 1212 depicted in the game outcome display area 1202 in FIG. 12, the feature game discussed above may be caused to be presented.

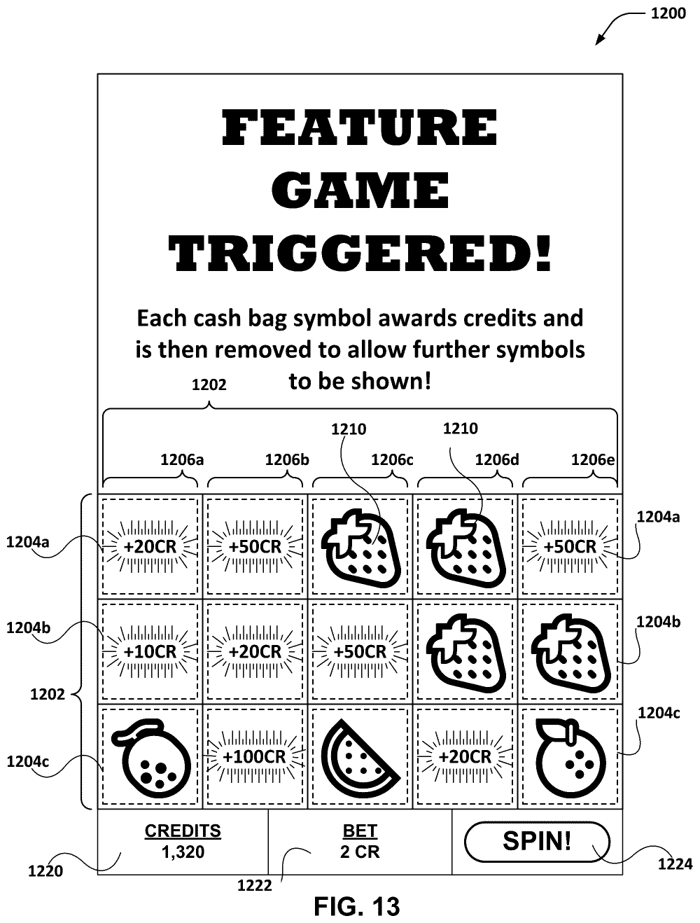

In FIG. 13, the symbols 1212 have been caused to disappear (or be removed from the game outcome display area 1202) as part of feature game play and, in their place, award indicators have been temporarily displayed that indicate credit amounts associated with each removed symbol 1212. The credit balance indicator 1220 is caused to be incremented by the total of the displayed credit amounts.

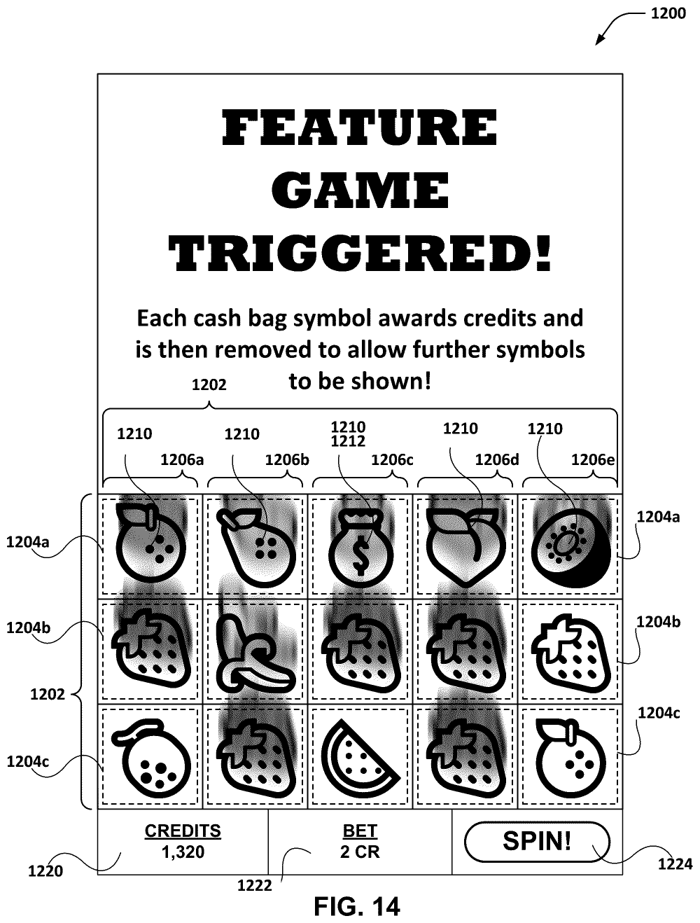

Subsequent to the removal of the symbols 1212 and the award of the amounts indicated by the award indicators, the game of chance may cause additional symbols 1210 to be selected and displayed in the strips 1206 of symbol positions 1204. As can be seen in FIG. 14, symbols 1210 that were selected to replace the removed symbols 1212 have been caused to move downward from the edge of the game outcome display area 1202 or from the upper portion of the game outcome display area 1202 to fill in the now-vacant symbol positions 1204 that may exist.

As can be seen in FIG. 14, there is actually a winning pattern of five strawberries along a W-shaped payline. Such a winning pattern may, as will be discussed with reference to later Figures, result in an award being awarded to the player if the winning pattern is still present at the conclusion of the feature game. However, as mentioned earlier, some implementations of games of chance may allow for such winning patterns to be identified during feature game play (as opposed to at the conclusion thereof). In this case, however, winning patterns are only identified and paid out after the conclusion of the feature game.

As can be seen in FIG. 14, two symbols 1210 that were not displayed as part of the game outcome have been selected for the symbol positions 1204 in the strip 1206a and have dropped into the symbol positions 1204a and 1204b of the strip 1206a. At the same time, three symbols 1210 that were not displayed as part of the game outcome have been selected for the symbol positions 1204 in the strip 1206b and have dropped into the symbol positions 1204a through 1204c of the strip 1206b. Finally, single symbols 1210 that were not displayed as part of the game outcome have been selected for symbol positions 1204 in each of the last three strips 1206, i.e., strips 1206c—e. Symbols 1210 that were already displayed in the game outcome display area 1202 and positioned “above” a symbol position 1204 from which a symbol 1210a was removed may be caused to fall into the now-vacant (or to-be-vacated) spot, while newly selected symbols 1210 may be caused to fall into the uppermost symbol positions 12104a in strips 1206c—e.

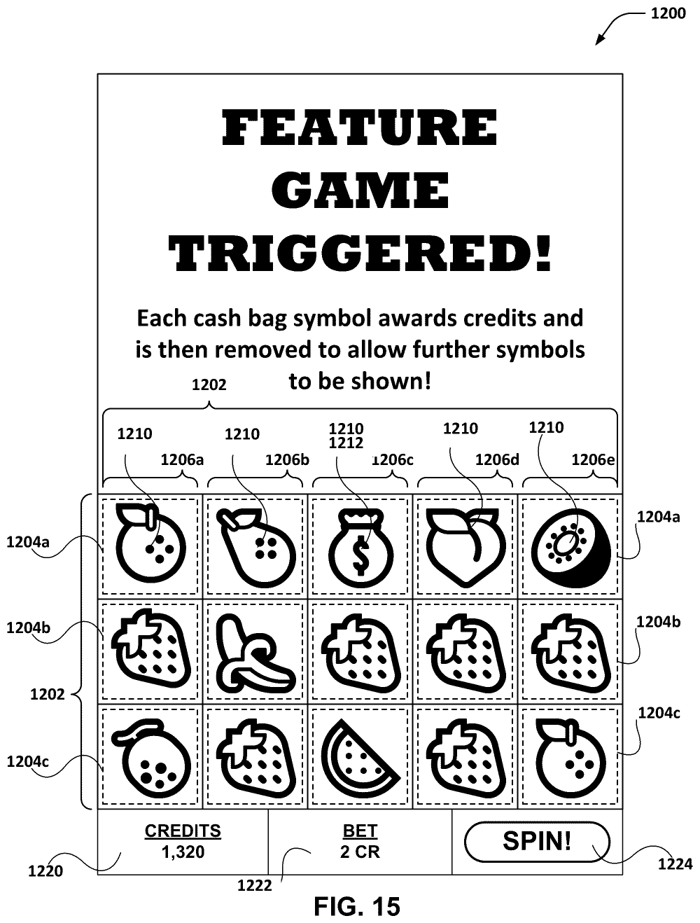

FIG. 15 depicts the game outcome display area 1202 after the first round of symbols 1210/1212 of the first category of symbols 1210 have been caused to be removed from the game outcome display area 1202. As can be seen, the newly selected symbols have caused an additional symbol 1210/1212 of the first category of symbols 1210 to be displayed in symbol position 1204a of the middle strip 1206c.

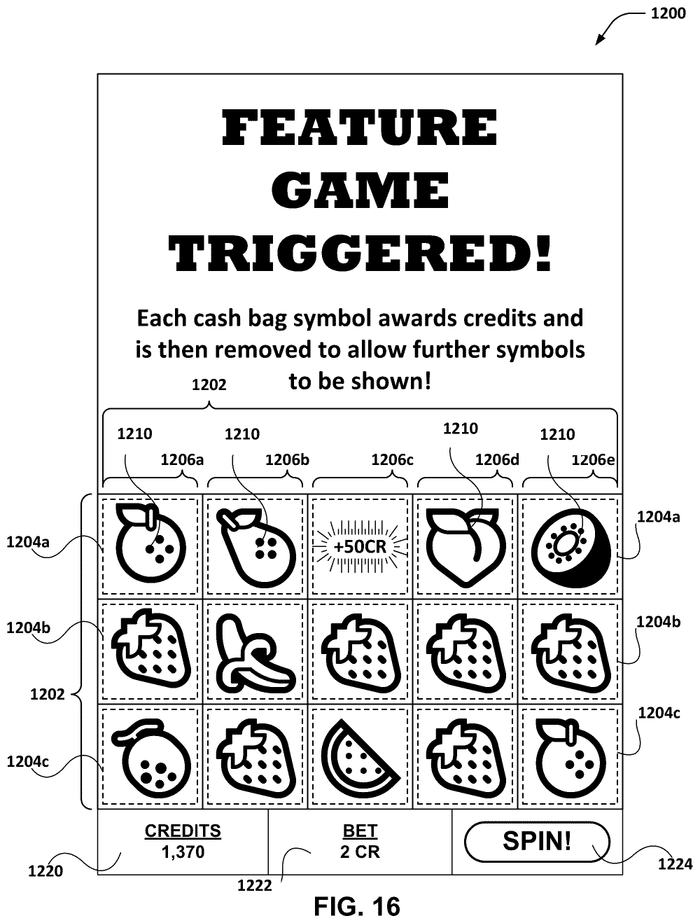

In FIG. 16, the symbol 1212 has been caused to disappear (or be removed from the game outcome display area 1202) as part of feature game play and, in its place, an award indicator has been temporarily displayed that indicates the credit amount associated with the removed symbol 1212. The credit balance indicator 1220 is caused to be incremented by this additional credit amount.

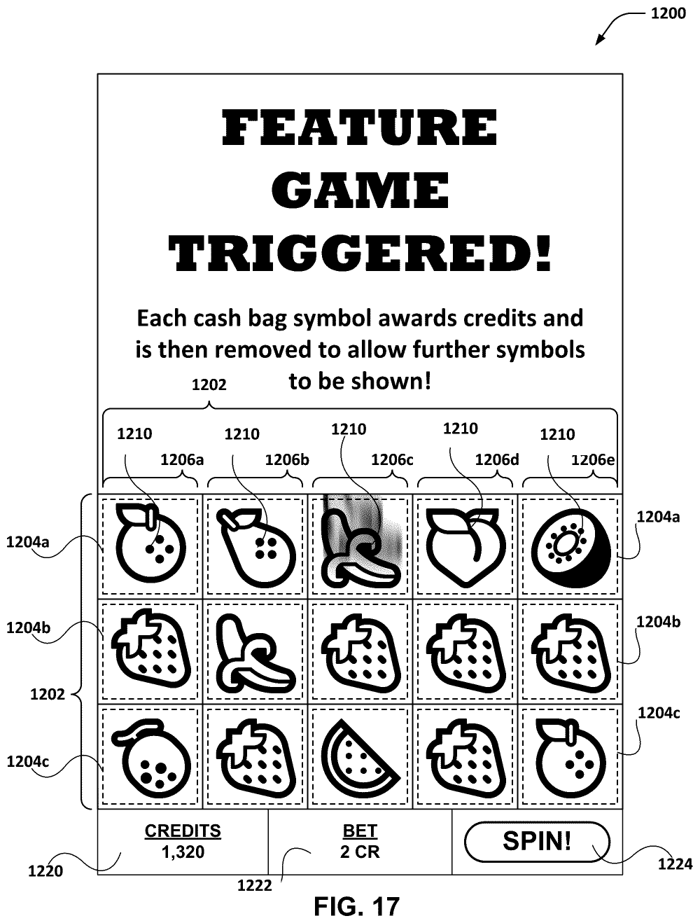

FIG. 17 depicts the game outcome display area 1202 after the second round of symbols 1210/1212 of the first category of symbols 1210 have been caused to be removed from the game outcome display area 1202 (in this case, a single symbol 1212). As can be seen, the newly selected symbols have caused an additional symbol 1210 to be displayed in symbol position 1204a of the middle strip 1206c.

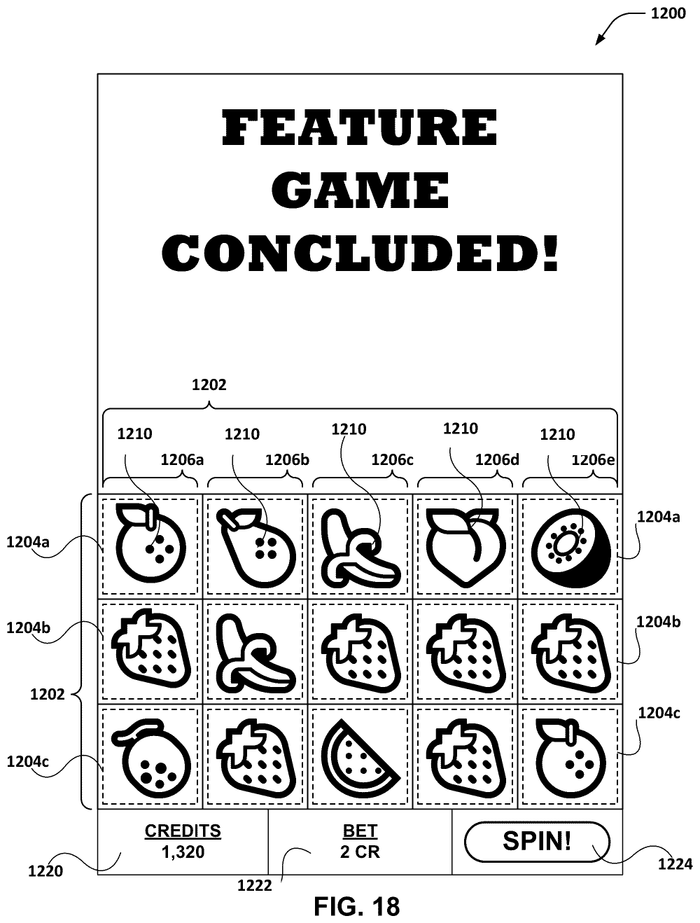

As can be seen in FIG. 18, the lack of any symbols 1210/1212 of the first category of symbols 1210 in the game outcome display area in FIG. 18 causes the game of chance to determine that the feature game has concluded, and the GUI is modified to indicate this change in state to the player.

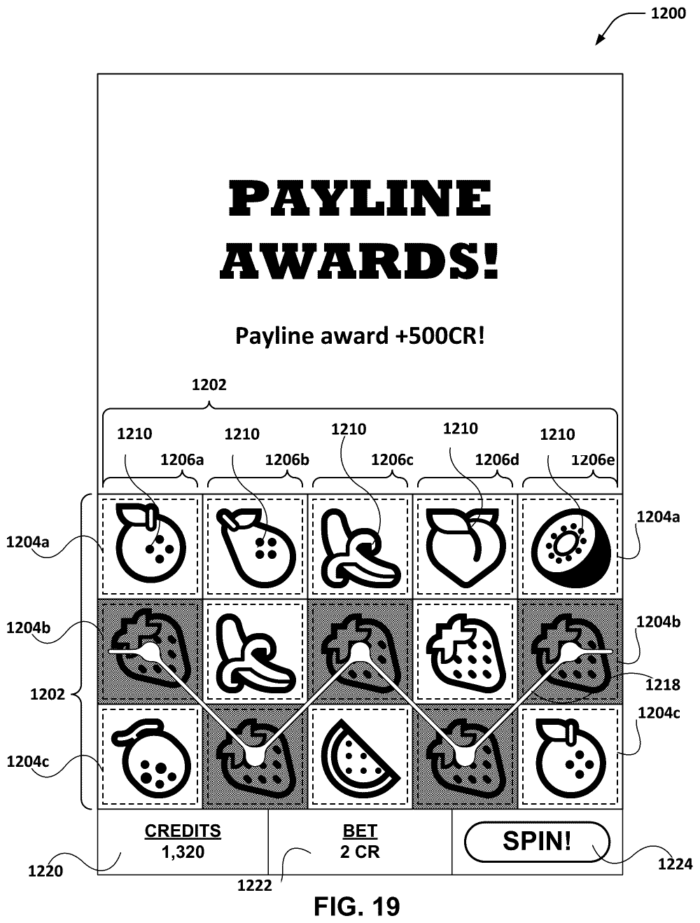

At the conclusion of the feature game, the GUI may then transition to a state in which the displayed symbols 1210 are evaluated to determine if any winning patterns (represented by the dark grey symbol positions 1204 in FIG. 19) are present along a payline 1218 of the game of chance, as shown in FIG. 19 (in which the winning pattern 1216 is along a W-shaped payline 1218). In this example, the winning pattern 1216 along the W-shaped payline 1218 has resulted in an additional 500 credits being awarded to the player. It will be appreciated that while the above examples have focused on payline-based games, the feature game mechanics discussed herein may also be applied to ways games and non-traditional games.

FIG. 20 depicts a flow chart of an example technique for providing the above-discussed feature game mechanic in a game of chance.

The technique of FIG. 20 may begin in block 2002, in which an input may be received, e.g., input provided via a touch control or button of an electronic gaming machine, that is indicative of a play of a game of chance (or an instruction to play a game of chance). The technique may then, on receipt of such an input, proceed to block 2004, in which subsets of symbols may be selected, e.g., randomly, from each of several sets of symbols. Each set of symbols from which a subset of symbols is selected may be associated with a different strip of symbol positions in a game outcome display area.

In block 2006, the symbols in each selected subset of symbols may be caused to be displayed in the symbol positions of a corresponding strip of symbol positions in the game outcome display area.

In block 2008, a determination may be made as to whether one or more feature game conditions are met; such feature game conditions may be as discussed above (such a determination may also be made, in some implementations, prior to the selection of the subsets or even prior to the receipt of the input indicating the play of the game of chance).

If it is determined in block 2008 that the one or more feature game conditions have not been met, then the technique may proceed to block 2018, in which the symbols that are displayed in the game outcome display area may be evaluated to determine if there are one or more winning patterns of such symbols displayed. In block 2020, an award may be caused to be provided to the player for each winning pattern that is present in the displayed symbols in the game outcome display area. The technique may then return to block 2002 without the feature game having been activated.

If it is determined in block 2008 that the one or more feature game conditions have been met, then the technique may proceed to block 2010, in which an award may be caused to be provided to the player for each symbol that is displayed in the game outcome display area that is of a first category of symbol.

In block 2012, each symbol of the first category of symbol that is displayed in the game outcome display area may be caused to be removed from the game outcome display area. Blocks 2010 and 2012 may also be performed in reverse order or concurrently.

After any displayed symbols of the first category of symbols have been removed from the game outcome display area in block 2012, the technique may proceed to block 2014, in which, for each symbol removed in block 2012, another symbol may be selected from the same set of symbols that the removed symbol was selected from and then displayed in a symbol position of the same strip of symbol positions that the removed symbol was removed from (or, put another way, from the strip of symbol positions associated with the set of symbols from which the additional symbol was selected).

In block 2016, a determination may be made as to whether there are any symbols of the first category displayed in the game outcome display area. If the determination is made that there are no such symbols presently being displayed, the feature game may terminate and the technique may proceed to block 2018, in which an evaluation may be made as to whether there are any winning patterns in the symbols that are shown in the game outcome display area, and then to block 2020 and then back to block 2002.

If the determination is made in block 2016 that there are one or more symbols of the first category displayed in the game outcome display area, then the technique may return to block 2010 and blocks 2010 through 2014 may be repeated until there are no further symbols of the first category of symbols displayed in the game outcome display area.

As noted earlier, the feature game mechanisms described above allow for a feature game to be provided that is similar to a hold-and-spin game except that such a feature game may allow for a player to win more awards associated with specific symbols during one game play than there are symbol positions in the game of chance. This allows for greater opportunities for players to achieve feature game winnings while, at the same time, avoiding the need to expand the game play area. This allows, for example, feature games with such enhanced winning opportunities to be presented in GUIs that may not have the space to support a larger GUI.

In addition to the above-described game mechanics, games of chance incorporating feature game mechanisms such as are described above may also, in some cases, include additional features. For example, in some games of chance, an additional award may be provided to a player during such a feature game when a running total of symbols of the first category of symbols that are displayed during a feature game exceeds a particular amount. For example, in some implementations, if the number of symbols of the first category of symbols that is displayed, in total, during a feature game exceeds the total number of symbol positions in the game outcome display area, then this may cause an additional award to be provided to the player. In some such implementations, such an award may be a multiplier that may cause all subsequent awards from the symbols of the first category of symbols during the feature game instance to be multiplied by the multiplier value. In other such implementations, the additional award may be a progressive award or the unlocking of a base game feature, e.g., a sticky wilds feature or multiplier feature that is used in the base game.

Another potential feature that may be implemented in feature games such as those discussed above is one in which an additional award may be provided based on the number of times that symbols of the first category of symbol are removed during the feature game (assuming that all symbol positions are caused to have symbols displayed therein prior to removing any symbols of the first category of symbols and assuming that all symbols of the first category of symbols that are simultaneously displayed in the game outcome display area are all removed before any new symbols are selected to replace them).

It will be understood that the various GUIs and game mechanics discussed herein may be implemented entirely locally, e.g., by a processor or processors of a single device, such as a smartphone, or may be provided using processors located in different devices or systems. Information regarding the selection of symbols, awards associated with special symbols, etc., may be transmitted, e.g., via a network connection (wired, wireless, or a mixture of both) to another device, e.g., a smartphone, the processor or processors of which may then implement the GUI and/or feature game mechanic using the information regarding the symbols, awards, etc. Such information may be generated and/or sent in response to receipt of a request from such another device, e.g., a request from a smartphone for the server to provide such information. Such distributed-computing implementations of the GUI provisioning techniques discussed herein is to be understood to also be within the scope of this disclosure.

It will be appreciated that in such distributed computing arrangements, the computer-executable instructions for implementing the GUI may be distributed between different memory devices located in different devices, e.g., the computer-executable instructions for selecting symbols stored on one or more memory devices of a server, while computer-executable instructions presenting the GUI.

In recognition of the possibility of such distributed processing arrangements, the term “collectively,” as used herein with reference to memory devices and/or processors or various other items, should be understood to indicate that the referenced collection of items has the characteristics or provides the functionalities that are associated with that collection. For example, if a server and a client device collectively store instructions for causing A, B, and C to occur, this encompasses at least the following scenarios:
a) The server stores instructions for causing A, B, and C to occur, but the client device stores no instructions that cause A, B, and C to occur.
b) The client device stores instructions for causing A, B, and C to occur, but the server stores no instructions that cause A, B, and C to occur.
c) The server stores instructions for causing a proper subset of A, B, and C to occur, e.g., A and B but not C, and the client device stores instructions that cause a different proper subset of A, B, and C to occur, e.g., C but not A and B, where instructions for causing each of A, B, and C to occur are respectively stored on either or both the client device and the server.
d) The server stores instructions for causing a subset of A, B, and C to occur, e.g., A and B but not C, and the client device stores instructions that cause a different subset of A, B, and C to occur, e.g., B and C but not A, where instructions for causing each of A, B, and C to occur are respectively stored on either or both the client device and the server.
e) The server stores instructions for causing A and a portion of B to occur, and the client device stores instructions that cause C and the remaining portion of B to occur.

In all of the above scenarios, between the server and the client device, there are, collectively, instructions that are stored for causing A, B, and C to occur, i.e., such instructions are stored on one or both devices and it will be recognized that using the term “collectively,” e.g., the server and the client device, collectively, store instructions for causing A, B, and C to occur, encompasses all of the above scenarios as well as additional, similar scenarios.

Similarly, a collection of processors, e.g., a first set of one or more processors and a second set of one or more processors, may be caused, collectively, to, perform one or more actions, e.g., actions A, B, and C. As with the previous example, various permutations fall within the scope of such “collective” language:
a) The first set of one or more processors may be caused to perform each of A, B, and C, and the second set of one or more processors may not perform any of A, B, or C.
b) The second set of one or more processors may be caused to perform each of A, B, and C, and the first set of one or more processors may not perform any of A, B, or C.
c) The first set of one or more processors may be caused to perform a proper subset of A, B, and C, and the second set of one or more processors may be caused to perform a different proper subset of A, B, and C to be performed such that between the two sets of processors, all of A, B, and C are caused to be performed.
d) The first set of one or more processors may be caused to perform A and a portion of B, and the second set of one or more processors may be caused to perform C and the remainder of B.

It is to be understood that the phrases “for each <item> of the one or more <items>,” “each <item> of the one or more <items>,” or the like, if used herein, are inclusive of both a single-item group and multiple-item groups, i.e., the phrase “for . . . each” is used in the sense that it is used in programming languages to refer to each item of whatever population of items is referenced. For example, if the population of items referenced is a single item, then “each” would refer to only that single item (despite the fact that dictionary definitions of “each” frequently define the term to refer to “every one of two or more things”) and would not imply that there must be at least two of those items.

The term “between,” as used herein and when used with a range of values, is to be understood, unless otherwise indicated, as being inclusive of the start and end values of that range. For example, between 1 and 5 is to be understood to be inclusive of the numbers 1, 2, 3, 4, and 5, not just the numbers 2, 3, and 4.

The use, if any, of ordinal indicators, e.g., (a), (b), (c) . . . or the like, in this disclosure and claims is to be understood as not conveying any particular order or sequence, except to the extent that such an order or sequence is explicitly indicated. For example, if there are three steps labeled (i), (ii), and (iii), it is to be understood that these steps may be performed in any order (or even concurrently, if not otherwise contraindicated) unless indicated otherwise. For example, if step (ii) involves the handling of an element that is created in step (i), then step (ii) may be viewed as happening at some point after step (i). Similarly, if step (i) involves the handling of an element that is created in step (ii), the reverse is to be understood. It is also to be understood that use of the ordinal indicator “first” herein, e.g., “a first item,” should not be read as suggesting, implicitly or inherently, that there is necessarily a “second” instance, e.g., “a second item.”

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. A system comprising:
one or more displays,
one or more processors, and
one or more memory devices, the one or more memory devices storing computer-executable instructions which, when executed by the one or more processors, cause the one or more processors to:
present a game of chance featuring a game outcome display area, the game outcome display area including a plurality of strips of symbol positions, each strip of symbol positions associated with a corresponding set of symbols; and
determine a game outcome for the game of chance responsive to receipt of an input signal indicating a play of the game of chance by:
a) causing, for each symbol position in each strip of symbol positions, a symbol from the corresponding set of symbols associated with that strip of symbol positions to be selected and displayed as a displayed symbol in that symbol position;
b) determining whether one or more feature game conditions have been met;
c) causing, responsive to determining that the one or more feature game conditions have been met, each displayed symbol that is of the first category of symbol to be removed from the game outcome display area and thereby become a removed symbol;
d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed;
e) repeating (c) and (d) until none of the symbols displayed concurrently in the symbol positions of the strips of symbol positions are of the first category of symbol;
f) causing, responsive to determining that the one or more feature game conditions have been met and for each displayed symbol of the first category of symbol that is displayed as part of the game outcome, a corresponding feature game award to be added to a credit balance associated with the game of chance;
g) determining whether the symbols displayed in the game outcome display area form one or more winning patterns; and
h) causing, for each winning pattern that is determined to be formed by the symbols displayed in the game outcome display area, a corresponding winning pattern award to be added to the credit balance.

2. The system of claim 1, wherein:
the symbol positions in each strip of symbol positions lie along a corresponding path,
the symbols in each set of symbols are in a predefined order, and
the one or more memory devices further store additional computer-executable instructions which, when executed by the one or more processors, cause the one or more processors to:
cause the symbols that are selected and displayed in the symbol positions of each strip of symbol positions to be displayed in the strip of symbol positions, and
select and display the symbols from each set of symbols in the same order that those symbols are in within that set of symbols.

3. The system of claim 2, wherein the one or more memory devices further store additional computer-executable instructions which, when executed by the one or more processors, cause the one or more processors to cause each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

4. The system of claim 1, wherein the first category of symbols includes two or more cash-on-reel symbols that are each associated with a different award amount.

5. The system of claim 1, wherein the one or more feature game conditions are met when at least a predetermined number of symbols of the first category of symbols are concurrently displayed in the game outcome display area as part of the game outcome.

6. The system of claim 1, wherein the one or more memory devices further store additional computer-executable instructions which, when executed by the one or more processors, cause the one or more processors to at least perform (g) and (h) after none of the symbols displayed concurrently in the symbol positions of the strips of symbol positions are of the first category of symbol.

7. The system of claim 6, wherein the one or more memory devices further store additional computer-executable instructions which, when executed by the one or more processors, cause the one or more processors to also perform (g) and (h) at least once in between (a) and (g).

8. A method comprising:
presenting a game of chance featuring a game outcome display area, the game outcome display area including a plurality of strips of symbol positions and each strip of symbol positions associated with a corresponding set of symbols; and
determining a game outcome for the game of chance responsive to receipt of an input signal indicating a play of the game of chance by:
a) causing, for each symbol position in each strip of symbol positions, a symbol from the corresponding set of symbols associated with that strip of symbol positions to be selected and displayed as a displayed symbol in that symbol position;
b) determining whether one or more feature game conditions have been met;
c) causing, responsive to determining that the one or more feature game conditions have been met, each displayed symbol that is of the first category of symbol to be removed from the game outcome display area and thereby become a removed symbol;
d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed;
e) repeating (c) and (d) until none of the symbols displayed concurrently in the symbol positions of the strips of symbol positions are of the first category of symbol;
f) causing, responsive to determining that the one or more feature game conditions have been met and for each displayed symbol of the first category of symbol that is displayed as part of the game outcome, a corresponding feature game award to be added to a credit balance associated with the game of chance;
g) determining whether the symbols displayed in the game outcome display area form one or more winning patterns; and
h) causing, for each winning pattern that is determined to be formed by the symbols displayed in the game outcome display area, a corresponding winning pattern award to be added to the credit balance.

9. The method of claim 8, wherein:
the symbol positions in each strip of symbol positions lie along a corresponding path,
the symbols in each set of symbols are in a predefined order, and
the method further comprises:
causing the symbols that are selected and displayed in the symbol positions of each strip of symbol positions to be displayed in the strip of symbol positions, and
selecting and displaying the symbols from each set of symbols in the same order that those symbols are in within that set of symbols.

10. The method of claim 9, further comprising causing each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

11. The method of claim 8, wherein the first category of symbols includes two or more cash-on-reel symbols that are each associated with a different award amount.

12. The method of claim 8, wherein the one or more feature game conditions are met when at least a predetermined number of symbols of the first category of symbols are concurrently displayed in the game outcome display area as part of the game outcome.

13. The method of claim 8, further comprising at least performing (g) and (h) after none of the symbols displayed concurrently in the symbol positions of the strips of symbol positions are of the first category of symbol.

14. The method of claim 13, further comprising performing (g) and (h) at least once in between (a) and (g).

15. One or more non-transitory, computer-readable media storing computer-executable instructions which, when executed by one or more processors, cause the one or more processors to:
cause a game of chance to be presented on one or more displays of a gaming machine and featuring a game outcome display area, the game outcome display area including a plurality of strips of symbol positions, each strip of symbol positions associated with a corresponding set of symbols; and
determine a game outcome for the game of chance responsive to receipt of an input signal indicating a play of the game of chance by:
a) causing, for each symbol position in each strip of symbol positions, a symbol from the corresponding set of symbols associated with that strip of symbol positions to be selected and displayed as a displayed symbol in that symbol position;
b) determining whether one or more feature game conditions have been met;
c) causing, responsive to determining that the one or more feature game conditions have been met, each displayed symbol that is of the first category of symbol to be removed from the game outcome display area and thereby become a removed symbol;
d) causing, for each removed symbol, an additional symbol from the same set of symbols from which that removed symbol was selected to be selected and then displayed as a displayed symbol in one of the symbol positions in the strip of symbol positions that includes the symbol position in which that removed symbol was displayed;
e) repeating (c) and (d) until none of the symbols displayed concurrently in the symbol positions of the strips of symbol positions are of the first category of symbol;
f) causing, responsive to determining that the one or more feature game conditions have been met and for each displayed symbol of the first category of symbol that is displayed as part of the game outcome, a corresponding feature game award to be added to a credit balance associated with the game of chance;
g) determining whether the symbols displayed in the game outcome display area form one or more winning patterns; and
h) causing, for each winning pattern that is determined to be formed by the symbols displayed in the game outcome display area, a corresponding winning pattern award to be added to the credit balance.

16. The one or more non-transitory, computer-readable media of claim 15, wherein:
the symbol positions in each strip of symbol positions lie along a corresponding path,
the symbols in each set of symbols are in a predefined order, and
the one or more non-transitory, computer-readable media further store computer-executable instructions which, when executed by the one or more processors, cause the one or more processors to:
cause the symbols that are selected and displayed in the symbol positions of each strip of symbol positions to be displayed in the strip of symbol positions, and
select and display the symbols from each set of symbols in the same order that those symbols are in within that set of symbols.

17. The one or more non-transitory, computer-readable media of claim 16, further storing additional computer-executable instructions which, when executed by the one or more processors, cause the one or more processors to cause each additional symbol to be displayed using an animation in which that additional symbol moves into an end-most symbol position of the symbol positions of the strip of symbol positions in which that additional symbol is to be displayed and in which each displayed symbol, if any, in a symbol position between that end-most symbol position and the symbol position of the removed symbol that the additional symbol was selected responsive to moves along the path and away from the end-most symbol position.

18. The one or more non-transitory, computer-readable media of claim 15, wherein the first category of symbols includes two or more cash-on-reel symbols that are each associated with a different award amount.

19. The one or more non-transitory, computer-readable media of claim 15, wherein the one or more feature game conditions are met when at least a predetermined number of symbols of the first category of symbols are concurrently displayed in the game outcome display area as part of the game outcome.

20. The one or more non-transitory, computer-readable media of claim 15, further storing additional computer-executable instructions which, when executed by the one or more processors, cause the one or more processors to at least perform (g) and (h) after none of the symbols displayed concurrently in the symbol positions of the strips of symbol positions are of the first category of symbol.
